(19) United States
(12) Patent Application Publication
(10) Pub. No.: US 2012/0166920 A1
(43) Pub. Date: Jun. 28, 2012

(54) CREATION OF CUSTOMIZED MULTIMEDIA EXPERIENCES BASED ON FUTURE OCCASIONS

(75) Inventor: Nabil Abujbara, Irvine, CA (US)

(73) Assignee: CANON KABUSHIKI KAISHA, Tokyo (JP)

(21) Appl. No.: 12/976,494

(22) Filed: Dec. 22, 2010

(51) Int. Cl. G06F 17/00

(52) U.S. Cl. 715/202

(57) ABSTRACT

Systems and methods for creating a customized multimedia experience based on future occasions detect a future occasion, determine a target audience for the future occasion, locate multimedia objects, identify multimedia objects associated with the future occasion, identify multimedia objects associated with the target audience, and generate a customized multimedia experience that includes at least some of the multimedia objects associated with the future occasion or the target audience.

### BACKGROUND

1. Field of the Disclosure

The present disclosure relates generally to the generation of multimedia presentations.

2. Description of the Related Art

With the popularity of digital cameras, digital camcorders, etc., users of these devices have wanted to share with others the large number of photos and videos captured by these devices. To share their photos and videos, users upload them to their personal computers, media servers on their home networks, Internet-based storage locations, or social networking web sites.

Currently, when a user wishes to display photos or videos containing specific individuals or relating to specific occasions, the user may need to spend an enormous amount of time locating the desired images by searching through all of the user's photos and videos in all of the various storage locations. Once the desired images have been selected, the user must then spend time manually putting the images into a single presentation that can then be shared with others.

In light of the above, what is needed is a way for proactively locating desired images and automatically creating a presentation based on the desired images to share with others in advance of a future occasion.

### SUMMARY

In one embodiment, a method for generating a customized multimedia presentation based on a future occasion comprises receiving future occasion data that defines a future occasion, receiving target audience data for the future occasion, wherein the target audience data indicates one or more individuals, receiving multimedia objects, identifying multimedia objects associated with the future occasion, identifying multimedia objects associated with the one or more individuals, and generating a multimedia presentation comprising at least some of the multimedia objects associated with the future occasion and at least some of the multimedia objects associated with the one or more individuals.

In one embodiment, a system for creating customized multimedia experiences based on future occasions comprises one or more local computer-readable storage devices, and one or more processors configured to detect a future occasion, locate one or more multimedia objects on one or more computer-readable storage devices, receive data defining a target audience, wherein the target audience comprises one or more individuals associated with the future occasion, determine one or more of the one or more multimedia objects that are associated with the future occasion and that are associated with the target audience, and generate a multimedia experience comprising at least some of the multimedia objects that are associated with the future occasion and the target audience.

In one embodiment, a computer-readable medium has computer executable instructions stored thereon, the instructions being executable by one or more computing devices in order to cause the one or more computing devices to perform operations comprising obtaining information indicating a future occasion, obtaining one

### BRIEF DESCRIPTION OF THE DRAWINGS

FIG. 1 is a block diagram of an illustrative embodiment of a system for the creation of customized multimedia experiences based on future occasions.

FIG. 2 is a block diagram of another illustrative embodiment of a system for the creation of customized multimedia experiences based on future occasions.

FIG. 3 is a flowchart of an illustrative embodiment of a method for creating customized multimedia experiences based on future occasions.

FIG. 4 is a flowchart of an illustrative embodiment of a method for determining multimedia objects

FIG. 5 is a flowchart of another illustrative embodiment of a method for creating customized multimedia experiences based on future occasions.

FIG. 6 is a flowchart of an illustrative embodiment of a method of selecting multimedia objects for a customized multimedia presentation.

FIG. 7 is a block diagram of an illustrative embodiment of the selection of multimedia objects for a customized multimedia presentation.

### DETAILED DESCRIPTION OF CERTAIN EMBODIMENTS

The following description is of certain illustrative embodiments, and it is understood that the disclosure is not limited to these embodiments, but includes alternatives, equivalents, and modifications such as are included within the scope of the claims.

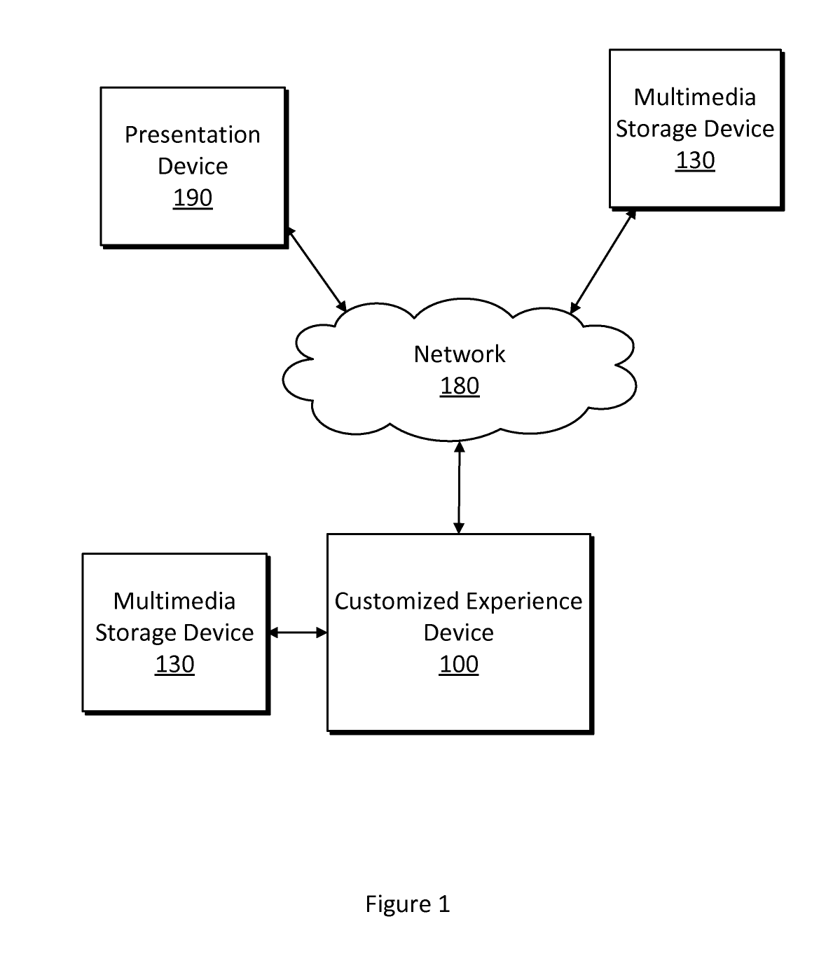

FIG. 1 is a block diagram of an illustrative embodiment of a system for the creation of customized multimedia experiences based on future occasions. The system includes a customized experience device 100, one or more multimedia storage devices 130, and a presentation device 190. In this embodiment, some of the devices communicate via a network 180. The network may include any combination of PANs, LANs, WANs, MANs, intranets, extranets, and the Internet, and may include any combination of wireless networks and wired networks.

The customized experience device 100 detects a future occasion and identifies a target audience for the occasion. The customized experience device 100 selects multimedia objects (also referred to herein as “MMOs”) from the multimedia storage devices 130 that are associated with the occasion or the target audience, and the customized experience device 100 generates a customized multimedia experience that includes the selected MMOs. As used herein, the conjunction “or” may refer to one or more of the alternatives that it joins. The customized experience device sends the customized multimedia experience to the presentation device 190 for presentation.

The customized experience device 100 includes one or more computing devices. By way of example and not limitation, computing devices include laptops, desktops, servers, mainframes, terminals, personal digital assistants, and phones. The customized experience device 100 stores occasion data that defines one or more future occasions. Occasions include, but are not limited to, a birthday, an anniversary, a graduation, a funeral, a wedding, a holiday, a going-away party, a celebration, an end of a school year party, a bridal shower, a vacation, and a baby shower, and, examples of a holiday include Christmas, Thanksgiving, Valentine's Day, Halloween, Hanukkah, Easter, New Year's Day, Boxing Day, Kwanzaa, Cinco de Mayo, Yule, Diwali, Eid ul-Fitr, Eid al-Adha, Vesak, Bon Festival, Naw Ruz, Samhaim, April Fools' Day, Independence Day, and Memorial Day, though a holiday may include any holiday not specifically listed.

Additionally, a target audience may be associated with an occasion. A target audience indicates one or more individuals, such as, for example, one or more individuals who may have the multimedia experience presented to them. Multimedia objects associated with the one or more individuals may be included in a multimedia experience. The target audience may be organized into a hierarchy or levels of priority, for example, as primary individuals and secondary individuals. Additionally, the target audience may indicate an individual whose associated MMOs are to be excluded from the presentation.

The customized experience device 100 communicates with the multimedia storage devices 130. The multimedia storage devices 130 include any device or combination of devices that may store multimedia objects, for example an internal hard drive, an external hard drive, a flash drive, an optical storage device, and/or a computing device. A multimedia object may include audio data or image data or both, and image data includes any images, for example videos and still photos. MMOs may also contain metadata which associates a respective MMO with certain individuals and occasions. Metadata includes, for example, date of creation, location, occasion, names of individuals appearing in an MMO, and other tags entered by users.

The multimedia storage devices 130 may make MMOs available via the network 180. For example, the multimedia storage device 130 may share MMOs via a general web page, a social web site, an email account, a photosharing web site (e.g., Picasa, Flickr), a blog (e.g., a photoblog), or other software (e.g., iPhoto, Adobe Photoshop Album). Therefore, a customized experience device 100 may locate more MMOs than a user has stored on a local computing device (e.g., a desktop) because the customized experience device 100 may search for MMOs in other storage locations, such as the user's email accounts, on the storage devices of friends and relatives, on web sites, etc.

Furthermore, the customized experience device 100 creates a customized experience that includes one or more of the located MMOs. The customized experience device 100 sends the customized experience to the presentation device 190. The presentation device 190 may be any device that is capable of presenting the customized experience, and may include any combination of one or more speakers, projectors, monitors, TVs (e.g., CRTs, LCD displays, Plasmas displays, DLP displays, etc.), set-top boxes, mobile devices, and digital video recorders. In the embodiment of FIG. 1, the customized experience is sent to the presentation device 190 via the network 180, though in other embodiments the customized experience may be transferred by other channels.

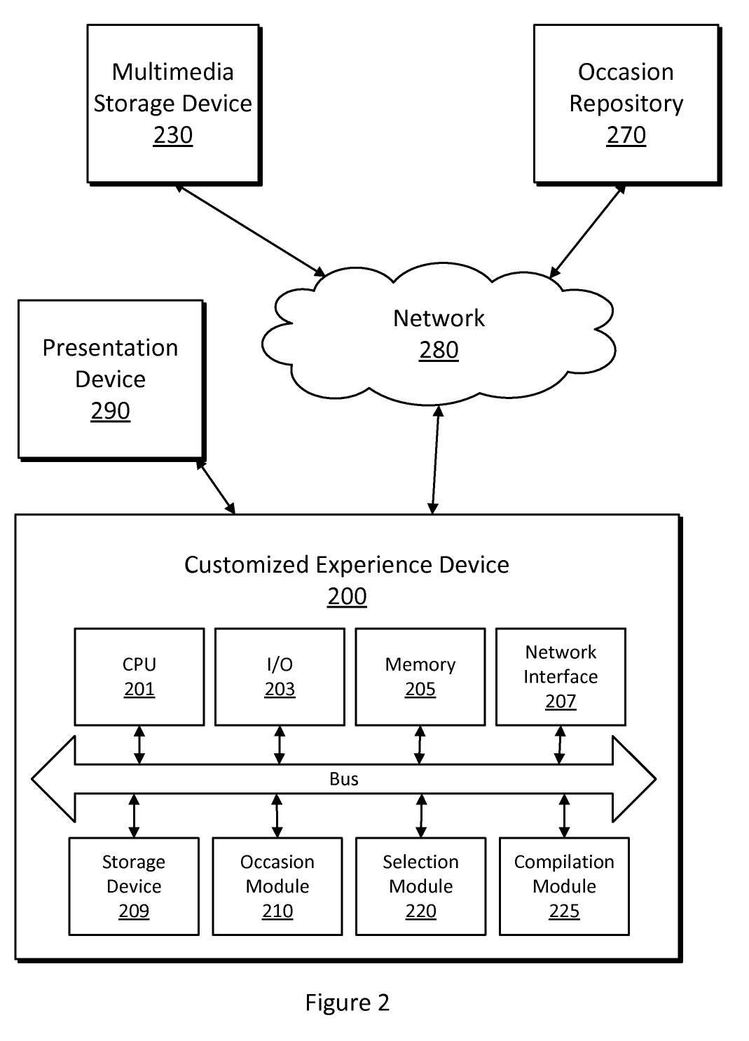

FIG. 2 is a block diagram of another illustrative embodiment of a system for the creation of customized multimedia experiences based on future occasions. In this embodiment, a customized experience device 200 is coupled to a multimedia storage device 230, an occasion repository 270 (e.g., a calendar application), and a presentation device 290. The occasion repository 270 stores occasion data that defines future occasions, and the customized experience device 200 communicates with the occasion repository 270 and the multimedia storage device 230 via the network. The customized experience device 200 communicates with the presentation device 290 through network 180 or through an alternative channel such as a direct wired or wireless connection.

The customized experience device 200 includes one or more CPUs 201, such as microprocessors configured to execute computer-readable instructions. The I/O interfaces 203 allow the customized experience device 200 to communicate with input and output devices, for example a keyboard, a mouse, a display device, a touch screen, a light pen, a microphone, an optical storage drive, and electromagnetic storage device, an electrical storage device, a camera, a printer, and a scanner.

The customized experience device 200 also includes memory 205, either volatile or non-volatile, such as ROM, RAM, and flash memory. The network interface 207 allows the customized experience device 200 to communicate with the network 180. The storage device 209 stores data and/or modules and may be a hard drive, optical storage device, or a diskette, for example. The components of the customized experience device 200 may communicate via a bus.

The customized experience device 200 also includes an occasion module 210, a selection module 220, and a compilation module 225. A module may be executed by the customized experience device 200 to cause the customized experience device 200 to perform certain operations, though for ease of description a module may be described as performing the operations. Modules may be implemented in software, firmware, and/or hardware. In other embodiments, the customized experience device 200 may include more or less modules, and/or the modules may be combined into fewer modules or divided into more modules.

The occasion module 210 includes instructions that cause the customized experience device 200 to detect future occasions and determine a respective target audience for the occasions. The occasion module 210 may access calendaring applications on the customized experience device 200 or on other devices (e.g., the occasion repository 270) to search for or import future occasions, or it may include its own calendaring functionality. One or more special occasion timers may be implemented in the occasion module 210 to generate reminders for upcoming occasions. These timers are used to start the operations for creating the custom multimedia presentation for the upcoming occasion. The occasion module 210 also associates a target audience with an occasion. An occasion (e.g. an occasion object) may include data that defines the target audience, or the target audience may be associated with the occasion by manual entry of the target audience, by importing a list (such as a group of email contacts or social network associates who were invited to attend the occasion, for example), and/or by any other manner which allows a target audience to be associated with an occasion.

The selection module 220 searches for, retrieves, and/or selects MMOs. The selection module 220 searches through the memory 205, the storage device 209, and/or the multimedia storage device(s) 230 for MMOs. A user may select search preferences for the selection module 220, including locations to search and desired MMO attributes, and/or the search preferences may be associated with an occasion or a target audience. Additionally, the selection module 220 may select at least some search preferences according to one or more algorithms.

For example, search preferences may direct a selection module 220 to search for MMOs only on the customized experience device 200. Also, the search preferences may direct a selection module 220 to search for MMOs available via the network, including MMOs available on the multimedia storage device 230. The selection module 220 may send requests and/or queries to the multimedia storage device 230, and the multimedia storage device 230 may then search through its stored MMOs and return the applicable MMOs or a list of the MMOs to the customized experience device 200. The selection module 220 may receive part or all of an MMO and/or part or all of the metadata associated with the MMO from the multimedia storage device 230.

After it locates an MMO, the selection module 220 may make a record of the MMO's location, or the selection module 220 may copy the MMO to another location, such as the storage device 209 or memory 205. Additionally, the selection module 220 selects MMOs associated with the occasion and/or the target audience. Some embodiments of MMO selection are described in further detail below.

Next, the compilation module 225 generates a customized experience using the selected MMOs. For example, the compilation module 225 may aggregate MMOs that comprise videos and still photos into a single video presentation (e.g., a wedding video). The customized experience may be generated using any format and any medium that allows the customized experience to be presented (e.g., EPG, DVD, CD, HD-DVD, Blu-Ray, VHS, MPEG, WAV, MP3, AVI, MOV, M4A, a streaming video, a hard drive, and a flash drive).

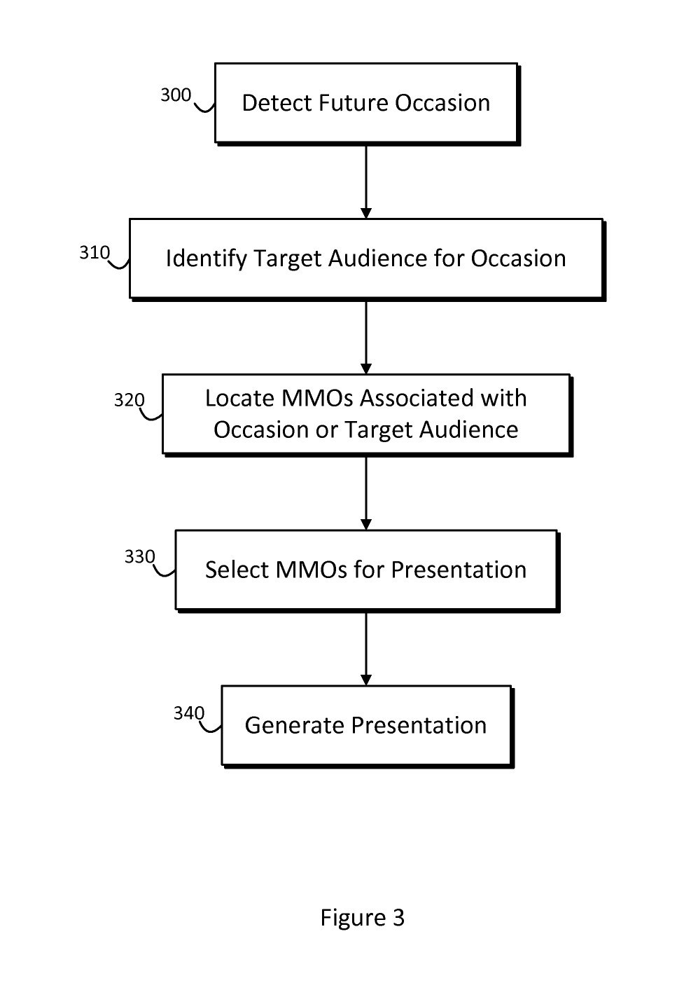

FIG. 3 is a flowchart of an illustrative embodiment of a method for creating customized multimedia experiences based on future occasions. Other embodiments may omit blocks, may change the order of the blocks, or may combine the blocks into fewer blocks or divide the blocks into more blocks.

Beginning in block 300, a future occasion is detected. In one embodiment a special occasion record is created to store special occasion dates which have been entered by the user over time. Special occasion dates include, for example, the birth of a new baby, family members and friends' birth dates, wedding date, high school and/or college graduation dates, holidays celebrated by the family, etc. One or more special occasion timers may be set to count down towards an upcoming occasion and expire a predetermined period of time before the occasion occurs, such as 1 day, 2 days, 1 week, or any other time period. The imminence of a future occasion is indicated when its timer expires.

Additionally, a customized experience device may access calendaring software on a laptop computer or on a PDA and search for occasions on the calendar that occur within a time period. If the date is Jan. 1, 2010, the calendar has a birthday scheduled on Jan. 5, 2010, and the search time period is a week (i.e., up to January 8), then the birthday on January 5 will be detected. The future occasion may also define one or more attributes of the occasion. The attributes may include, for example, a time period (e.g., specific date range, certain recurring dates (e.g., holidays)), themes (e.g., Christmas lights, 4th of July colors, birthday candles), locations (e.g., a school, a house, a mountain), and activities (e.g., sports, work), as well as any other attribute that may be associated with an occasion.

Moving to block 310, the target audience for the occasion is identified. The target audience includes one or more individuals that are associated with the occasion, such as the individuals who are expected to attend the occasion or view the customized multimedia experience. For example, if the occasion is a family Thanksgiving dinner, the target audience may be the members of the family, or if the occasion is a Quinceañera, the target audience may be the girl who is celebrating her fifteenth birthday, her parents, siblings, and best friends.

The target audience may also indicate the attributes of an individual in the target audience. The attributes may include a name (including first and last names), a birthday, an age, a facial appearance, a body appearance, various preferences of the individual (e.g., activities, favorite vacation locations, favorite music, people, pets), and any other attribute that may be associated with the individual. An individual's attributes are used to determine MMOs that are associated with the individual.

The target audience may include a set of primary individuals and a set of secondary individuals. The primary individuals may be of particular importance to the occasion. For example, if the occasion is a birthday for Bill, Bill may be a primary individual and the MMOs that are selected for the customized experience may be more likely to be associated with Bill. Or, if the occasion is a wedding of Jane and John, both Jane and John may be primary individuals, and the MMOs that are selected for the customized experience may need to include Jane and/or John and their favorite people, places, music, activities, etc.

The secondary individuals may be other individuals that are expected to attend the occasion or view the customized experience. Continuing the preceding examples, the secondary individuals may be other individuals that are expected to attend Bill's birthday party or other individuals that are expected to attend Jane and John's wedding. Secondary individuals may also include individuals unable to attend the occasion who would like to experience the occasion's multimedia presentation, either remotely or at a later time, and would like to have MMOs which are associated with them included in the future occasion presentation.

Furthermore, the target audience may include deceased individuals, for example an individual for whom a funeral service is being held and/or deceased family or friends of an individual. The target audience may include one or more pets, such as pets of an individual. Also, the pets and/or deceased persons may be identified as primary and/or secondary individuals. Additionally, the target audience may indicate other attributes associated with one or more individuals in the target audience, such as favorite locations, vacations, honeymoon photos, videos shot by one or more individuals in the target audience, favorite songs of one or more individuals in the target audience, etc.

Next, in block 320 MMOs are located that are associated with the occasion or the target audience. The search for the MMOs may include any device that stores MMOs (e.g., multimedia storage devices). The MMOs may be located by any means, including sending out queries to other devices (e.g., SQL), searching through files in local memory, etc. The location of part or all of the accessible MMOs may be recorded or part or all of the located MMOs (or the associated metadata) may be copied to a local storage device. Also, the MMO search may be restricted to predefined parameters, and MMOs with attributes that meet predefined criteria (e.g., MMOs that fall within a predefined date range, MMOs whose metadata indicates an individual in the target audience, MMOs tagged as containing the primary individuals' favorite locations, favorite living or late relatives or friends, childhood memories), or MMOs which were used in a multimedia presentation constructed for a similar previous occasion, may be copied (or have their metadata copied) and/or may have their respective locations recorded.

Moving to block 330, MMOs are selected for a presentation. The selection may be performed by comparing an MMO's attributes to the occasion attributes or the target audience attributes to determine if the attributes are associated with each other. The attribute comparison may involve data comparison (e.g., tagged as favorites, tagged as “use for occasions A, B, C”), image recognition, voice recognition, and any other applicable technique. Attributes may be associated if they are similar, substantially identical, fall within a predetermined range of each other, etc. If the MMO attributes are associated with the attributes of the occasion or the target audience, the MMO may be selected for the presentation.

For example, if the target audience attributes include a facial image of John and an MMO's (e.g., a photo) attributes includes a facial image that is substantially similar to the facial image of John, then the MMO may be determined to be associated with John. Also for example, if the occasion is Valentine's Day and Feb. 14, 2011 is an occasion attribute, then an MMO that was created on Feb. 14, 2010 may be determined to be associated with Valentine's Day.

In some embodiments, an MMO does not need to include an individual to be selected for the presentation. For example, an MMO associated with an individual's favorite location, honeymoon or favorite movie, or a video shot by an individual may be selected even if no individual appears in the MMO.

The MMOs may be selected according to a quota for each individual or for a set of individuals. A quota may specify a minimum number, a maximum number, a minimum percentage, a maximum percentage, or any other quantity or range of quantities. The target audience attributes may include a quota for each individual (which may be the same or different for each individual) and a quota for MMOs associated with sets of individuals.

The target audience may include a hierarchy, for example, primary individuals and secondary individuals, and MMOs may be selected based on the hierarchy. Using the example of a hierarchy that includes primary individuals and secondary individuals, the quota for MMOs that are associated with primary individuals may be different (e.g., greater, less) than the quota for MMOs that are associated with secondary individuals. For example, the primary individual quota may be 100 and the secondary individual quota may be 50, or the primary individual quota may be 90% and the secondary individual quota may be 30%.

Following the example of Jane's birthday, Jane may be a primary individual and her friend Jill may be a secondary individual. Every selected MMO may need to be associated with Jane, and 4 of the selected MMOs or 10% of the selected MMOs (as well as any other number of MMOs) may also need to be associated with Jill. Thus, when the presentation is displayed at Jane's birthday party, which Jill is expected to attend, Jane will be in every MMO but Jill will also be shown in at least some of the MMOs in the presentation.

Also, a quota may be associated with a set of individuals (e.g., 2 individuals, 11 individuals). By way of another example, if the occasion is a party to celebrate the end of the season for a team in a basketball league, every player on the team may be a primary individual, and the parents of the team members may be secondary individuals. A quota is assigned to the primary individuals (i.e., the team members) or groups of the primary individuals. Thus, a predetermined number of MMOs (e.g., 20%, 34) that are associated with a quantity of team members (e.g., 2, 4, 6, or 10 team members) may be selected. More than one quota for the MMOs and the quantity of individuals may be used. Thus, 10% of the MMOs may need to include 5 or more team members, 30% may need to include 2 or more, 2% may need to include 8 or more, etc. Similarly, quotas may be assigned to the secondary individuals and/or groups of the secondary individuals (i.e., the parents).

Next, in block 340 a presentation is generated using at least some of the selected MMOs. The presentation may also include other content, for example other audio data (e.g., music), user-generated content (also referred to herein as “UGC”), etc. The presentation may include image data or audio data, such as a video, a slideshow set to music, etc., and the presentation may be stored in any suitable format.

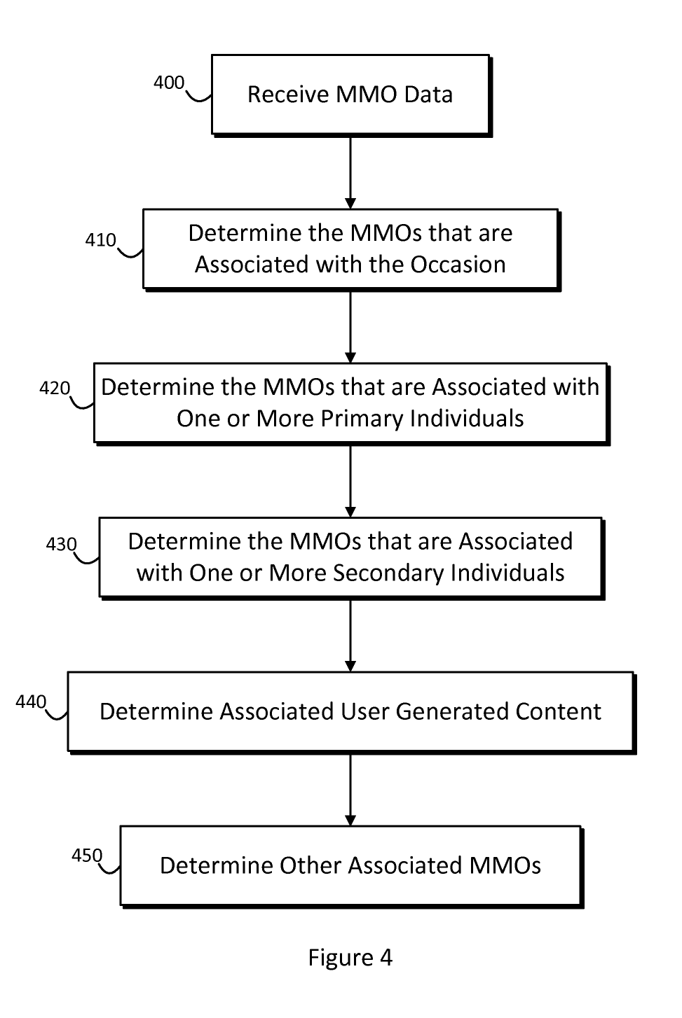

FIG. 4 is a flowchart of an illustrative embodiment of a method for determining multimedia objects. Other embodiments may omit blocks, may change the order of the blocks, or may combine the blocks into fewer blocks or divide the blocks into more blocks.

Beginning in block 400, MMO data is received. The MMO data may include all or part of the data associated with an MMO, such as the MMO itself, the metadata, etc.

Next, in block 410, the MMOs that are associated with the occasion are determined. This may be accomplished by comparing an MMO's attributes to the occasion attributes. For example, if the occasion is a birthday on Jan. 1, 2010 and one of the attributes of the birthday is a date range of one year preceding the birthday, MMOs that fall between Jan. 1, 2009, and Jan. 1, 2010 may be selected. By way of another example, the occasion attributes may specify colors, such as the colors associated with Independence Day, Christmas, Valentine's Day, etc., and the associated MMOs may be determined based on the color attributes of the respective MMOs. One

Moving to block 420, the MMOs that are associated with one or more primary individuals are determined. Thus, if the primary individuals include Jane, the method determines if MMOs are associated with Jane. Some or all of the MMOs that are determined to be associated with the primary individuals may be determined to be associated with the occasion in block 410.

Next, in block 430, the MMOs that are associated with the one or more secondary individuals are determined. Thus, if the secondary individuals include Bob, the method determines MMOs that are associated with Bob based on their attributes. Some or all of the MMOs that are determined to be associated with secondary individuals may be associated with the occasion in block 410 or the primary individuals in block 420.

In block 440, UGC is determined. UGC includes publically available media objects produced by end users, such as audio data and image data. User generated content may be determined to be associated with the occasion, the primary individuals, and/or the secondary individuals. For example, if the occasion is a wedding anniversary, user generated content (e.g., photos, videos, music available on popular internet sites such as YouTube) may be determined based on the date that the user generated content was made available or popular and the date of the wedding and/or which was tagged as favorite in the couple's attributes. Finally, in block 450, other MMOs are determined. These other MMOs may include background music, video clips, and other still images which for example, have been tagged as favorites of the bride and groom although they may not contain images of the bride or groom. For the sake of simplicity, MMOs associated with the audience list, UGC objects, and the other MMOs described above will be collectively referred to as MMOs.

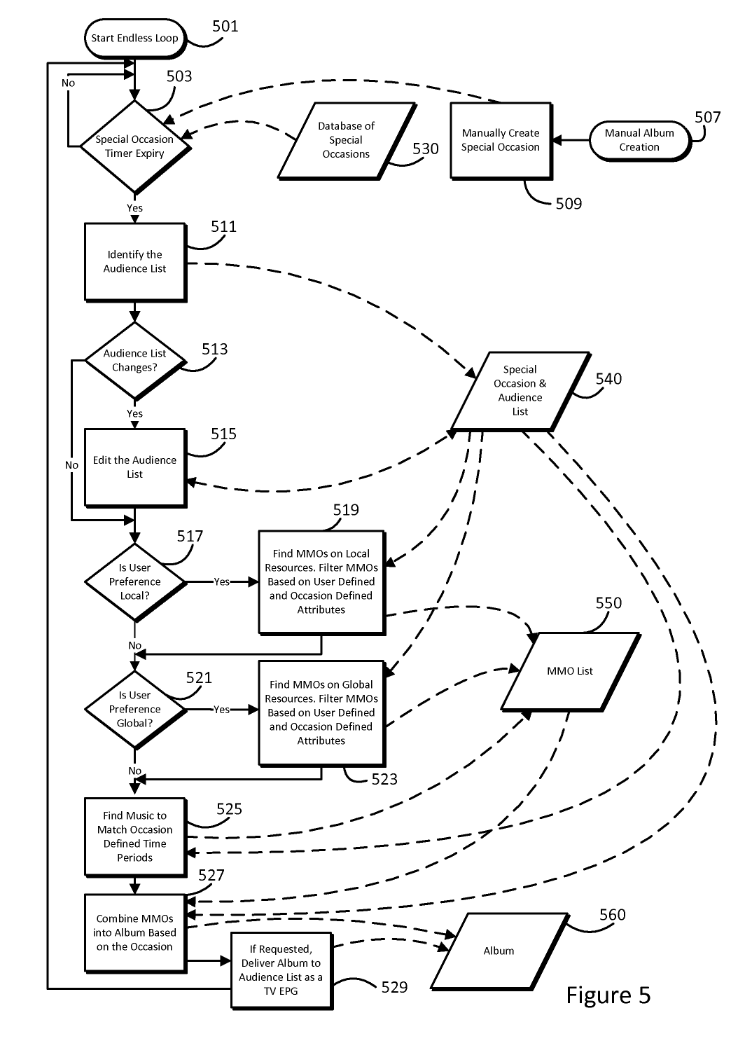

FIG. 5 is a flowchart of another illustrative embodiment of a method for creating customized multimedia experiences based on future occasions. Other embodiments may omit blocks, may change the order of the blocks, or may combine the blocks into fewer blocks or divide the blocks into more blocks.

The method begins in block 501, where an endless loop is started. In block 503, a special occasion is detected upon the expiry of a preset special occasion timer. One or more preset special occasion timers may be stored in a database of special occasions 530. The preset special occasion timer may expire any period of time before the occasion (e.g., 1 day, 5 hours, 4 days, 1 week, 1 month). Also, in block 507, manual album creation may be initiated, and in block 509 an individual may manually create a special occasion, and, depending on the embodiment, a special occasion created in block 509 is stored in the database of special occasions 530. If a special occasion timer expires or a special occasion is otherwise detected, such as by accessing a calendar, the method proceeds to block 511. Also, in some embodiments the method proceeds to block 511 without the expiry of a special occasion timer when a special occasion is manually created in block 509.

In block 511 the audience list for the special occasion is identified. The audience list may include one or more individuals. In block 513, the method determines if changes to the audience list are to be made, for example an addition of an individual or a deletion of an individual. If a change to the audience list is to be made, then in block 515 the special occasion and audience list 540 is accordingly edited. If no change is to be made, then the method proceeds to block 517.

In block 517, the method determines if a user has a local preference for MMOs. If the user does not have a local preference the method proceeds to block 521. However, if the user has a local preference, then, in block 519, MMOs are found on local storage resources. The MMOs are also filtered based on user defined and occasion defined attributes. The MMOs are then added to the MMO list 550, and the method moves to block 521.

In block 521, the method determines if the user has a global preference. If the user has a global preference, the method proceeds to block 523, where MMOs are found on global storage resources. The MMOs are then filtered based on user defined and occasion defined attributes, and the MMOs are added to the MMO list 550.

After block 523 (or block 521 if the user did not have a global preference), in block 525, music (e.g., background music) is found to match the occasion defined time periods. For example, if the occasion defined time periods are the last year, music may be selected that was popular during the last year. As a second example, if the special occasion is a wedding anniversary, music may be selected that was tagged as their favorite during the dating days of the celebrating couple. A third example would be adding the school or college sports team cheer song or fight song to the multimedia presentation if the special occasion is a class reunion or sports team celebration. Any located music MMOs are added to the MMO list 550.

Moving to block 527, at least some of the MMOs from the MMO list 550 are combined into an album 560 based on the occasion type. Next, in block 529, if requested, the album is delivered to the individuals in the audience list as a TV EPG (interactive/electronic programming guide feature). However, as described above, the album may be generated or delivered in any applicable format or medium, such as a Blu-ray, a DVD, an MPEG file, etc. Finally, the method returns to block 503 and waits for an indication that another special occasion is upcoming.

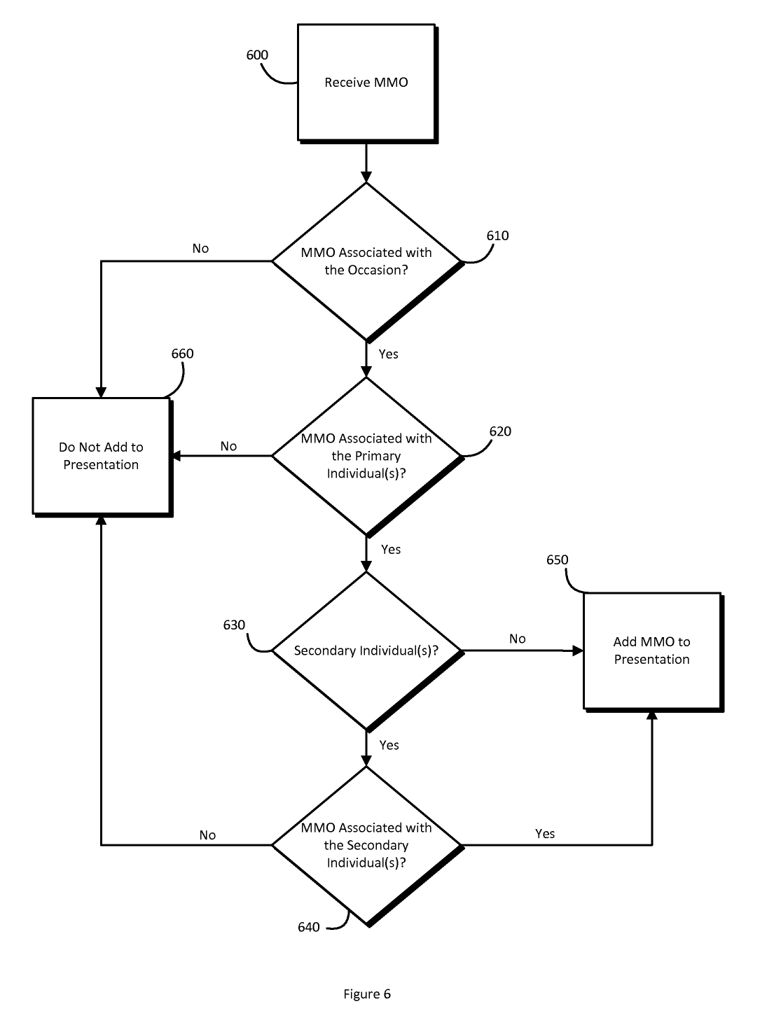

FIG. 6 is a flowchart of an illustrative embodiment of a method of selecting multimedia objects for a customized multimedia presentation. Other embodiments may omit blocks, may change the order of the blocks, or may combine the blocks into fewer blocks or divide the blocks into more blocks.

Starting in block 600, an MMO is received, for example an MMO that is retrieved by the MMO search engine. Next, in block 610, the method determines if the MMO is associated with the occasion. The determination may be based on the attributes of the occasion and attributes of the MMO. If the MMO is not associated with the occasion, the method proceeds to block 660 and the MMO is not added to the presentation.

If the MMO is associated with the occasion, the method proceeds to block 620, where it determines if the MMO is associated with the primary individual(s), for example by comparing the attributes of the MMO and the attributes of the primary individual(s). If the MMO is not associated with the primary individual(s), the method proceeds to block 660 and the MMO is not added to the presentation. If the MMO is associated with the primary individual(s), the method proceeds to block 630 and determines if there are any secondary individuals associated with the occasion. If there are no secondary individuals, then the method proceeds to block 650 and the MMO is added to the presentation.

However, if there are secondary individuals, the method proceeds to block 640 where it determines if the MMO is associated with the secondary individual(s). If the MMO is associated with the secondary individual(s), then, in block 650, the MMO is added to the presentation. Otherwise, the method proceeds to block 660 where the MMO is not added to the presentation. In other embodiments, the MMO is added to the presentation even if the MMO is not associated with the secondary individual(s) and/or an MMO is added to the presentation if it is associated with a secondary individual even if the MMO is not associated with a primary individual.

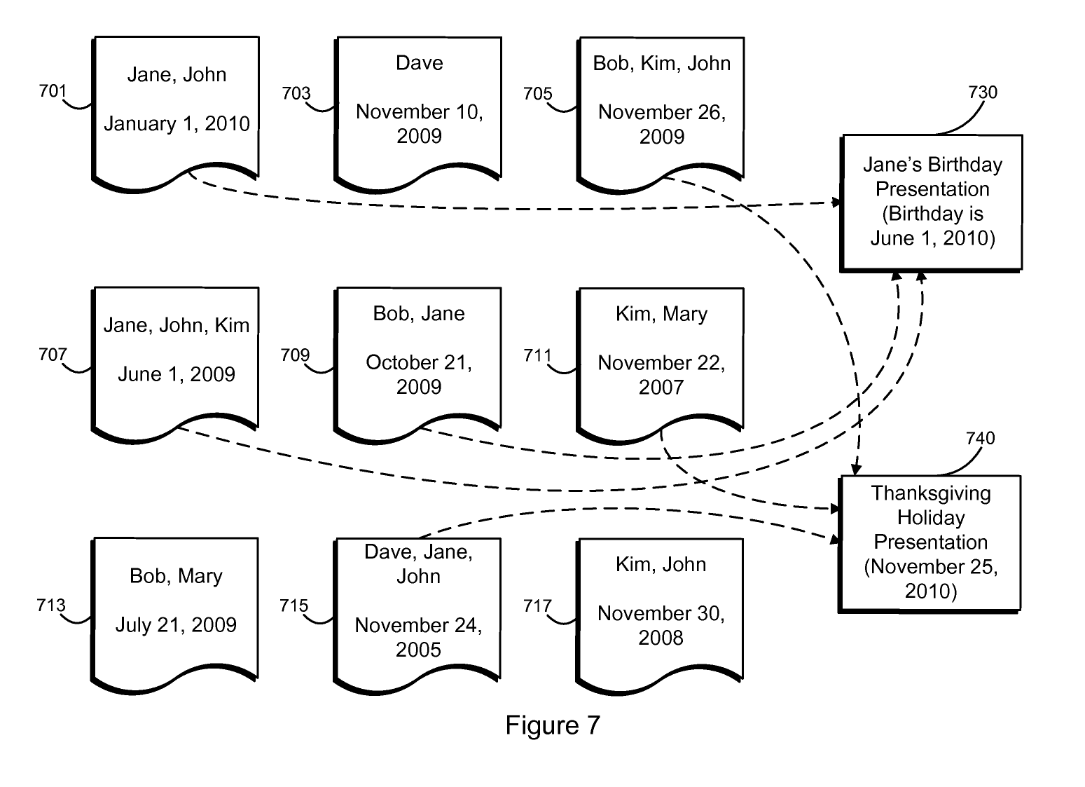

FIG. 7 is a block diagram of an illustrative embodiment of selecting multimedia objects for a customized multimedia presentation. In particular, FIG. 7 shows the selection of MMOs for Jane's birthday presentation and for a Thanksgiving holiday presentation. In this example, Jane's upcoming birthday is Jun. 1, 2010, and Thanksgiving is celebrated on Nov. 25, 2010. In this embodiment, the occasion of Jane's birthday presentation includes a date range of the year preceding the occasion, Jane is the primary audience, and John is the secondary audience. Furthermore, in this embodiment all MMOs in Jane's birthday presentation 730 must be associated with Jane.

FIG. 7 also shows MMOs 701-717. Each of the MMOs' respective attributes include a date of creation and one or more individuals that the MMO is associated with (e.g., individuals whose image or voice is included in the MMO and MMOs that are tagged as associated with an individual). For instance, MMO 701 was created on Jan. 1, 2010, and is associated with Jane and John (for example a photo of Jane and John that was taken on Jan. 1, 2010, or a photo of Jane's sister Jenna as indicated by the metadata of MMO 701).

As the MMOs are being selected, for example by a customized experience device 100, MMO 701 is determined to have a date within one year of the occasion date of Jane's birthday and is determined to be associated with Jane (and, depending on the embodiment, also with John). Because MMO 701 satisfies the criteria (the date range and target audience) for the occasion of Jane's birthday, MMO 701 is added to Jane's birthday presentation 730. In contrast, MMO 703 is determined to neither fall within the date range nor be associated with Jane, and is thus not included in Jane's birthday presentation 730. Likewise, MMO's 711, 715, and 717 are also determined to fall outside the date range and are not included.

MMOs 705, 707, 709, and 713 all fall within the date range for Jane's birthday, but MMOs 705 and 713 are not associated with Jane. Since this embodiment requires all MMOs in Jane's birthday presentation 730 to be associated with Jane, these MMOs are not included. However, in other embodiments one or more of these MMOs

In regards to the Thanksgiving holiday presentation 740, the occasion attributes include MMOs that were created within 7 days of a previous Thanksgiving holiday. Previous Thanksgiving dates include Nov. 26, 2009, Nov. 27, 2008, Nov. 22, 2007, and Nov. 24, 2005. The occasion attributes also include a target audience of Bob, Dave, Jane, and Mary, and an MMO must be associated with at least one individual in the target audience to be included in the Thanksgiving holiday presentation 740.

MMOs 701, 703, 707, 709, and 713 do not fall within the requisite date range and are accordingly not included in the Thanksgiving Holiday presentation 740. MMOs 705, 711, 715, and 717 fall within the date range, but MMO 717 is not associated with a member of the target audience and is thus not included. However, MMOs 705, 711, and 715 are also associated with members of the target audience and are therefore included in the Thanksgiving holiday presentation 740.

In another illustrative embodiment, to be included in the Thanksgiving holiday presentation 740 an MMO need be associated with only members of the target audience. According to this embodiment, if Dave is not a member of the target audience and Jane and John are, then MMO 715 would not be included even though it falls within the date range because it is also associated with Dave. Also, if Dave was on an excluded audience list, then MMO 715 would not be included in the Thanksgiving holiday presentation.

It is to be understood that the above described features can be achieved by a method in which a storage medium is supplied to a system or device, the storage medium having computer-executable instructions for realizing the above described operations, and a computing device (e.g., CPU and MPU) for the system or device that reads the computer-executable instructions stored in the storage medium and executes them.

In this case, the computer-executable instructions when read from the storage medium and performed by the computing device execute the operations of the above described embodiments. Thus, the computer-executable instructions or the storage medium storing the computer-executable instructions therein constitute an embodiment. As a storage medium for supplying the computer-executable instructions (e.g., a floppy disk, a hard disk, an optical disk, a magneto-optical disk, a CD-ROM, a CD-R, a magnetic tape, a non-volatile memory card, and a ROM) any applicable computer-readable storage medium can be employed.

When the computer-executable instructions are executed by a computing system, not only are the above described operations of the embodiments realized, but also an operating system working on the computing system may carry out part or all of the actual processing that realizes the operations of the above described embodiments.

The computer-executable instructions may be written to a memory provided on a function-extension board inserted into the computing device or on a function-extension unit connected to the computing device, and a CPU provided on the function-extension board or unit may carry out part of all of the actual processing that realizes the operations of the above described embodiments.

While the above disclosure describes illustrative embodiments, it is to be understood that the invention is not limited to the above disclosure. To the contrary, the invention covers various modifications and equivalent arrangements within the spirit and scope of the appended claims.

What is claimed is:

1. A method for generating a customized multimedia presentation based on a future occasion, the method comprising:
receiving future occasion data that defines a future occasion;
receiving target audience data for the future occasion, wherein the target audience data indicates one or more individuals;
receiving multimedia objects;
identifying multimedia objects associated with the future occasion;
identifying multimedia objects associated with the one or more individuals; and
generating a multimedia presentation including at least some of the multimedia objects associated with the future occasion and at least some of the multimedia objects associated with the one or more individuals.

2. The method of claim 1, wherein
the future occasion data includes one or more attributes of the future occasion,
wherein the multimedia objects associated with the future occasion are identified based on one or more attributes of the multimedia objects and the one or more attributes of the future occasion,
wherein the target audience data includes one or more attributes of a respective individual of the one or more individuals, and
wherein the multimedia objects associated with the one or more individuals are identified based on the one or more attributes of the multimedia objects and the one or more attributes of a respective individual of the one or more individuals.

3. The method of claim 2, wherein the one or more attributes of the multimedia objects include one or more of content of a respective object and metadata of a respective object, wherein metadata includes data added by users for the purpose of matching one or more multimedia objects with a future occasion or individuals.

4. The method of claim 3, wherein metadata includes one or more of a date a respective object was created, a location where a respective object was created, and an occasion.

5. The method of claim 2, wherein
the one or more attributes of the future occasion include one or more of a calendar date of the future occasion, a theme of the future occasion, one or more colors associated with the future occasion, and a time period associated with the future occasion, and
wherein the one or more attributes of a respective individual include one or more of the following: a name, a facial image, other individuals or animals indicated as favorites, favorite locations, favorite foods, favorite artists, favorite music, and favorite TV shows or movies.

6. The method of claim 1, wherein the one or more individuals include one or more primary individuals, and wherein the one or more individuals further include one or more secondary individuals.

7. The method of claim 6, wherein every multimedia object identified as associated with the one or more individuals is associated with at least one of the one or more primary individuals.

8. The method of claim 6, wherein one or more multimedia objects identified as associated with the one or more individuals are associated with at least one of the one or more secondary individuals.

9. The method of claim 1, wherein multimedia objects include one or more of image data and audio data.

10. The method of claim 1, further comprising excluding multimedia objects associated with an excluded audience from the multimedia presentation, wherein the excluded audience includes one or more excluded individuals.

11. The method of claim 1, further comprising
locating user-generated multimedia objects; and
identifying user-generated multimedia objects associated with the occasion,
wherein the multimedia presentation includes a user-generated multimedia object associated with the occasion.

12. The method of claim 1, further comprising transmitting the multimedia presentation to a display device.

13. The method of claim 1, wherein the multimedia presentation includes at least some multimedia objects associated with both the future occasion and the one or more individuals.

14. A system for creating customized multimedia experiences based on future occasions, the system comprising:
one or more local computer-readable storage devices; and
one or more processors configured to
detect a future occasion;
locate one or more multimedia objects on one or more computer-readable storage devices;
receive data defining a target audience, wherein the target audience includes one or more individuals associated with the future occasion;
determine one or more of the one or more multimedia objects that are associated with the future occasion and that are associated with the target audience; and
generate a multimedia experience including at least some of the multimedia objects that are associated with the future occasion and the target audience.

15. The system of claim 14, wherein the target audience includes one or more primary individuals and one or more secondary individuals.

16. The system of claim 15, wherein the multimedia experience includes at least a predetermined number of multimedia objects associated with both one or more of the one or more primary individuals and one or more of the one or more secondary individuals.

17. The system of claim 14, wherein the one or more processors are configured to receive user-identified multimedia objects to include in the multimedia experience, and wherein the multimedia experience includes the user-identified multimedia objects.

18. A computer-readable medium having computer executable instructions stored thereon, the instructions being executable by one or more computing devices in order to cause the one or more computing devices to perform operations comprising:
obtaining information indicating a future occasion;
obtaining one or more multimedia objects;
obtaining information indicating one or more target individuals associated with the future occasion;
determining one or more multimedia objects associated with the one or more target individuals; and
generating a multimedia presentation including one or more multimedia objects associated with the one or more target individuals.

19. The computer-readable medium of claim 18, wherein the operations further comprise
obtaining user-generated content objects; and
determining one or more user-generated content objects associated with the one or more target individuals,
wherein the multimedia presentation further includes one or more of the one of more user-generated content objects associated with the one or more target individuals.

20. The computer-readable medium of claim 18, wherein the future occasion includes a date that is within a predetermined period of time.
